(19) United States
(12) Patent Application Publication
(10) Pub. No.: US 2008/0260243 A1
(43) Pub. Date: Oct. 23, 2008

(54) Device of Analysing the Colour of a Unhomogeneous Material, Like Hair, and Method Thereof

(75) Inventor: Alessandro Occelli, Manta (Cuneo) (IT)

Correspondence Address: HESLIN ROTHENBERG FARLEY & MESITI PC, 5 COLUMBIA CIRCLE, ALBANY, NY, 12203, US

(73) Assignee: HAIR STYLING APPLICATIONS S.P.A., Varese (IT)

(21) Appl. No.: 11/814,887

(22) PCT Filed: Jan. 27, 2006
(86) PCT No.: PCT/IB06/00468

§ 371 Date: Jul. 26, 2007

(30) Foreign Application Priority Data
Feb. 8, 2005 (IT) TO2005A000070

(51) Int. Cl. G06K 9/46

(52) U.S. Cl. 382/165

(57) ABSTRACT

A device for analyzing the color of a nonhomogeneous material, utilizable for example for analysing the hair color of an individual includes at least one of an illumination source for illuminating the above sample of a nonhomogeneous material, a display structure for exposing the sample of a nonhomogeneous material to the radiation emitted from the illumination source, detection means for the digital acquisition of the image of the sample illuminated from the illumination source, and processing means for transforming the digital acquisition readings of the image of said detection means in coordinates comparable with the perception of the human eye.

The present invention relates to a device for analysing the colour of a unhomogeneous material, such as hair, and the method thereof.

The determination of the colour of a body substantially consists of the measurement of the intensity and the spectral composition of the electromagnetic radiations included in the visible spectrum transmitted or reflected by the body. The determination of the colour of a body with an unhomogeneous surface aspect (in the following, a constant reference to the case of hair will be made) is a quite delicate and complex analysis, as the body/sample to be analyzed is not a homogeneous sample, but a sample characterized by a high unhomogeneity.

The hair reflect the light which hit them but also give rise to internal reflection and refraction phenomena, which determine the formation of zones with a different degree of brightness and shadow zones substantially generated by the interstitial spaces between one hair and another.

All these reflection and refraction phenomena affect the perception of the hair colour and therefore the difficult encountered in the colour determination of a lock or a head of hair is apparent.

The classical calorimetric methods which involve the measurement of the colour coordinates by reflection calorimeters, absorption spectrophotometers in the visible spectrum or spectrocolorimeters did not give appreciable results on the hair. The calorimetric analyses of this type read, in fact, the colour by a “punctual” measurement, namely on a very limited surface of the object to be analyzed. Systems of this type are optimal for objects with homogeneous surfaces and are largely used for the reading of the colour in different industrial ambits, for example in the textile industry, paints industry, etc.

The attempts for applying the calorimetric analyses to the determination of the hair colour have substantially failed for the inadequacy of such equipments to determine the colour of a sample characterized by a so high unhomogeneity. In fact, the carrying out of the colour reading of a head of hair with this kind of equipment involves the obtainment of deeply different values depending on the reading “point”. The differences between the values thus obtained are such that it is almost impossible to define “the colour” of a lock or a head of hair.

The trichologic sector for defining the hair colour uses, still today, systems of an empiric type by defining the colour according to a scale of tone heights and primary and secondary reflections. These three parameters are classified with some numbers, giving rise to a composite code which is used by the manufacturers of hair dyes and by the world-wide hairdressers for defining the colouring which one desires to apply to the hair. For example, with the code 5.43 the pale brown tone with golden copper reflections is defined. However, it is a matter of a system having not much objective codes and affected by the subjective reading that each individual gives to the colour.

In the trichologic sector, the need of supplanting the old system of empiric colour coding with scientific, as much objective as possible and universally accepted methods, is therefore very high.

At the patent level, different documents which face up the problem of the hair characterization are known. Among these, there can be mentioned, for example, documents such as U.S. Pat. No. 6,719,565 or U.S. Pat. No. 6,707,929, substantially relating to systems which process photographic images of hair and propose colour changes in accordance with the proposed dye. There are no references with respect to how to solve the problems of scientifically correct acquisition of the colour (illumination and detection of the colour). Substantially similar considerations apply to documents like DE-A-102 407 80 or DE-A-101 425 26. Moreover, there are other documents, such as U.S. Pat. No. 6,437,863, U.S. Pat. No. 6,330,341, U.S. Pat. No. 6,314,372, U.S. Pat. No. 6,308,088, U.S. Pat. No. 6,151,445, U.S. Pat. No. 6,129,664 or U.S. Pat. No. 6,067,504 which face up to the colour analysis, for example of hair, in a more scientific way. The used instruments is, however, of a traditional type (calorimeters, spectrocolorimeters, spectrophotometers). Usually, neither the problem of a reading comparable with the vision of the eye, nor the problem of a possible “punctual” reading of the calorimeter is faced up.

The fact that all over the world the empiric codes are still used testifies that the calorimetric methods have not given results useful for the definition of the hair colour.

The object of the present invention is to provide a solution capable to overcome the drawbacks of the known art above delineated.

According to the present invention, such aim is attained thanks to a device having the features specifically referred in the following claims. The invention also relates to the relating method.

The claims form an integral part of the technical teaching provided herein with reference to the invention.

The present invention is able to provide an objective measurement of the hair colour, and particularly of the “mean colour” of the hair.

In particular, the device according to the present invention allows to define the colour with numerical notations directly bound to the light reflected by the surface of the hair, minimizing the interferences determined from the intrinsic unhomogeneity of the sample to be analyzed.

The invention will be now described, by mere way of not limiting example, with reference to the enclosed drawings, wherein:

FIG. 1 represents a general block diagram of the device according to the present invention;

FIG. 2, including three portions shown by 2a, 2b and 2c, respectively, is a more detailed depiction of a first embodiment of part of the device of FIG. 1;

FIG. 3, including three portions shown by 3a, 3b and 3c, respectively, is a more detailed depiction of a second embodiment of the same part of the device of FIG. 1;

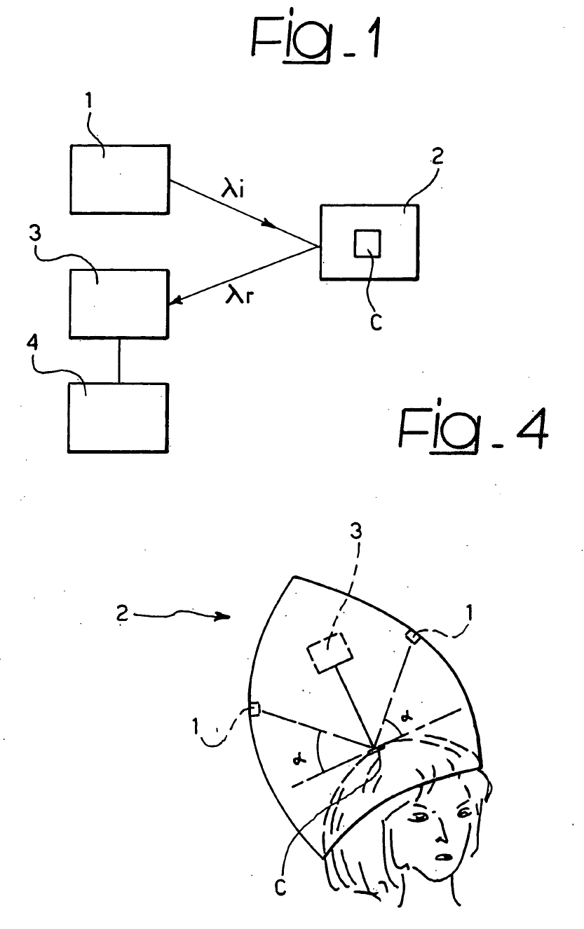

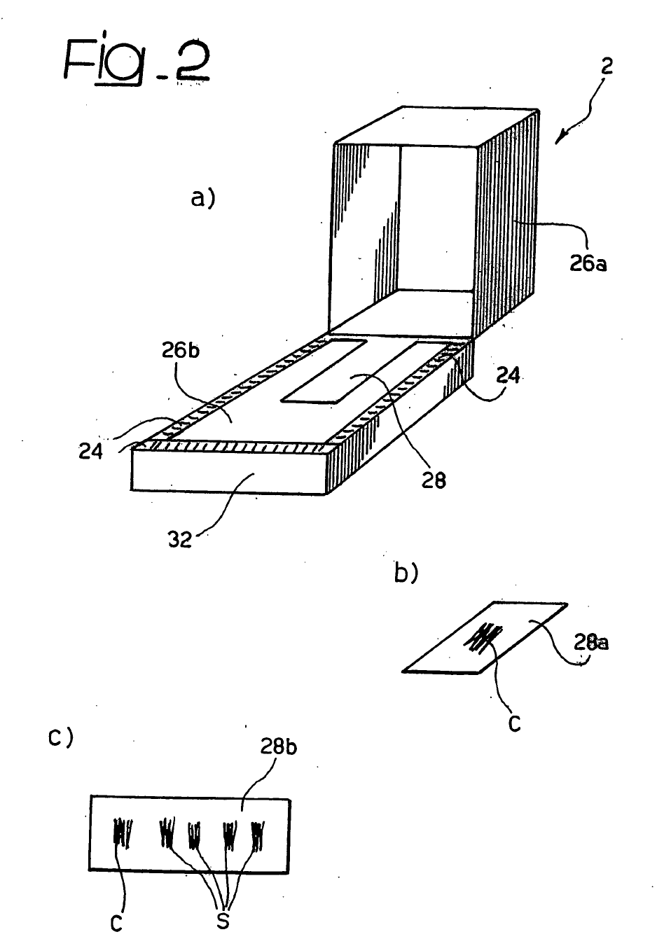

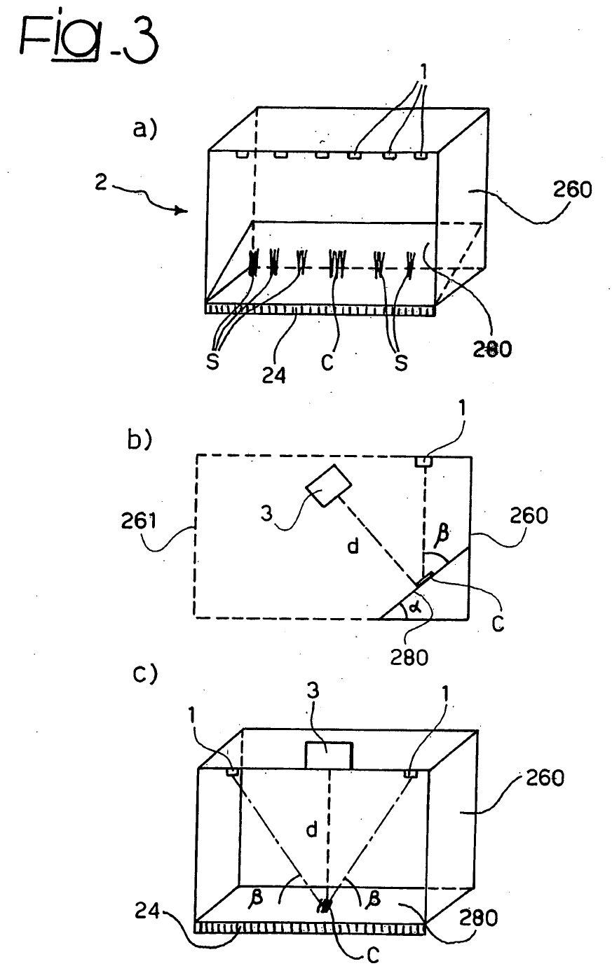

FIG. 4 represents a third possible embodiment of the same part of the device of FIG. 1.

Referring to the FIG. 1, by 1 illumination means, utilizable in the ambit of the present invention for illuminate a trichostructure sample (for example a lock of hair C) of which one desires to analyze the colour are generally shown. In general, it is a matter of illumination means which i) minimize the creation of shadows, ii) reduce the internal reflection phenomena and iii) do not overheat the sample C for the purpose of avoiding colour alterations.

Depending on the type of the required application, there can be used incandescent lamps, fluorescent lamps, discharge lamps (for example the xenon discharge lamps), light-emitting diodes (LEDs) or optical fibers associated with a light source, with a colour temperature approximately between 4000 and 7500° Kalvin. Depending on the type of illumination that one desires to employ for the determination of the colour, such illumination means will be oriented so as to produce a light beam λ₁, which hits the sample C, of a diffused type or having an angle of incidence on the sample approximately equal to 45° or 90°.

The illumination means 1 utilizable in the ambit of the present invention allow to meet different requirements of determination of the hair colour. Think, for example, to the different need of reading the colour of the dyed hair from a dyes preparer or from a hairdresser.

In the first case, an “absolute” reading of the colour is required, for the purpose of being able to carry out comparisons between the different colouring agents, creating numerical databases and/or images with data relating to the different colouring agents. For this application, it is therefore opportune to operate with a radiation and then with an illumination source suitable for a merely chromatic evaluation of the colour, corresponding with a colour temperature of about 6500° Kelvin.

In the second case, on the contrary, the hairdresser will have to evaluate the colouring applied to the hair in the way as close as possible to the yield that will be obtained under the natural light, which corresponds to a colour temperature of about 5500° Kelvin.

The sample C hit by the illuminating radiation coming from the source 1 is placed in an exposure or display structure 2. Exposure structures 2 advantageously utilizable in the ambit of the present invention consist of dark rooms (that is structures which do not give rise to light reflection phenomena) shaped so as to allow the detection of the reflected light r from the sample C to be analyzed and from the colour standards. Alternatively, also chambers with a completely reflecting internal surface can be used, so as to subject the sample to a light diffused in each directions, with dark zones for trapping the light reflected in a specular way and allow the reading of the sole light diffused by the sample.

Such dark rooms are shaped so as to allow the use of samples in form of single hair, locks or heads of hairs.

The geometry of the exposure structure 2 is such to allow a constancy of the illumination and detection/reading conditions of the reflected light λᵣ (diffused reflection) and therefore a good reproductibility of the measurements. Preferably, the exposure structure 2 simultaneously allows the observation of the hair from an operator and the automatic detection of the reflection data, so as to allow a constant comparison between the colour evaluation from the human eye and the instrumental reading through a detection unit 3 which will be described in the following.

The availability of reference samples (generally called colour “standards”) allows, in fact, the calibration and the adjusting of the unit 3, including detection means of the reflected light. The standards change as a function of the hair colour to be analyzed; in order to obtain a good colour measurement, in fact, it is required to use standards having colours similar to the hair colour to be analyzed (think to the differences of natural colour of the hair of a Nordic, Oriental, South American type, or to the different decolouring degrees or still to hair dyed in the more diversified shades). Such standards consist of both objects of a known colour (paper, ceramic tiles or plastic materials), whose colour is simultaneously determined/stored to the sample of hair of interest, and in digital profiles (files) of proper colours already stored in the data processing means.

For the purpose of detecting the light reflected from the sample C (and from the standards), the unit 3 substantially includes an electronic image acquisition device, such as for example a scanner, a digital camera or videocamera. Whatever they are, such digital acquisition means of the light information must not be of the type equipped with functions (typically softwares) with an automatic correction ability of the colour or, in case these functions are present, they must be deactivable. Such a chromatic correction function should affect, in fact, the detection data in a negative way.

Together with the detection unit 3 there are means 4 for a digital processing and display of the collected images. These are substantially formed by a personal computer and its relative pheripherals. These have such features to optimize the reading steps of the digital images and colour data processing originated from such images. In particular, in the ambit of the personal computer 4, functions for the management of the colour profiles, the selection of the reading areas of the digital image, the selected reading of colours (for example in order to remove residual shadow zones), the transformation of the digital image (for example in order to determinate the gray colour), the creation of calibration curves and/or colour bar graphs, the data exportation, as well as the management of the colour on the printing peripherals and the monitor calibration are useful.

The means for the determination of the mean colour included in the personal computer 4 are typically formed by a software (of a type per se known, for example Image pro Plus or for application in the sector of the printers) capable to perform a statistical treatment of the colour data previously generated. Particularly preferred is the representation of the colour of the digital image by bar graphs disclosing the number of pixels belonging to the different levels of colour for each channel of the RGB system (normally used in the digital systems) and the following transformation from RGB notations to other coordinates of colour representation, for example XYZ, three-chromatic coordinates L*, a*, b* in the colorimetric space CIELAB (also shown as CIE 1976) or others. An example of conversion from the RGB colour notation to the three-chromatic coordinates L*, a*, b* is given in table 1.

TABLE 1

| | R | G | B | L | a | b |
|---|---|---|---|---|---|---|
| Sample | 151.85 | 150.08 | 144.38 | 62.1051 | −0.48008 | 3.269023 |
| 1 | | | | | | |
| Sample | 156.41 | 152.93 | 150.26 | 63.40903 | 0.707399 | 1.88866 |
| 2 | | | | | | |
| Sample | 143.78 | 136.89 | 106.98 | 56.91353 | −2.53144 | 17.05424 |
| 3 | | | | | | |

For the interconversion between the different reference scales of the colour, some routines, available on line on the site http://www.easyrgb.com, have been used.

The bar graphs representation allows to graphically describe the mean colour of the sample and subsequently determine the corresponding average and standard or mean deviation values.

The conversion from a RGB measurement system to another (for example in the system XYZ or L*a*b*) allows to measure the hair colour through notations which can be better compared with the colour reading of the human eye. In particular, in the adjusting of the method, a correlation between the luminosity and gray scale levels with the parameter of the tone height commonly used by the operators of the trichologic sector for defining the light/shade level of the hair has been found. At the same way, the coordinates a* and b* can be used, directly or properly processed, for the definition of the reflections of primary and secondary tone.

Some embodiments of the structure 2 for the exposure of the sample C and the colour standards (if necessary) advantageously utilizable in the ambit of the present invention are shown in the FIGS. 2, 3 and 4.

In particular, in FIG. 2 a diagrammatic depiction of a “dark room” utilizable together with a scanner as the means 3 for the digital detection and storage is provided.

In FIG. 2, a structure 26a having the form of a parallelepiped box, at least internally of a non reflecting black colour, with five full sides and one empty, applicable like a cover on the top of the scanning plane of a scanner 32 is therefore visible. By 26b a foil, with a non reflecting black colour, which ideally forms the sixth side of the structure 26a so as to create a real dark room is shown. The foil 26b is directly placed in contact with the screen of the scanner 32.

The foil 26b presents a removed portion 28 within which a support 28a, 28b is positioned (also having a non reflecting black colour) for the exposure of the sample of hair (single hair or locks) and the possible colour standards, when necessary (FIGS. 2b and 2c).

The “dark room” 2 also foresees a registers system 24 for allowing the proper positioning of the support 28a, 28b with respect to the illumination means 1 and the detection and storage means 3 (in the case of FIG. 2a formed by the “head” of the scanner 32, which frames the sample C (or the standard) placed in the support 28a, 28b), so as to allow the recording of the sample position and consequently the reproductibility of the illumination and detection conditions of the reflected light λᵣ. In FIG. 2a, the registers system 24 is substantially formed by a series of three rulers orthogonal therebetween.

The applicant has successfully used, as a scanner 32, an Epson 1680 scanner. For the purposes of the carrying out of the solution described herein, any other type of professional scanner capable of ensuring correctness of the reading colour can be however used.

Typically, the distance of the bottom of the dark room from the sample surface placed on the scanner glass is of at least 4 cm.

The exposure structure 2 depicted in FIG. 3 is utilizable when one desires to carry out the colour determination of a sample of hair (single hair or locks of hair), when the detection means 3 are formed by a digital camera/videocamera.

The exposure means 2 shown in the FIGS. 3a and 3c essentially consist of a box-shaped structure 260 having the form of a parallelepiped, at least internally of a non-reflecting black colour, with five full sides and one empty. Within the structure 260, on the upper side, illumination means 1 are arranged.

The sample to be analyzed and the colour standards, if any, are placed on a support 280 (also in this case of a non-reflecting black colour) equipped with a registers system 240 for allowing the proper positioning thereof with respect to the illumination means 1 and the detection means 3 for the purposes of allowing the reproduction of the illumination and detection conditions of the reflected light λᵣ.

The support 280 can be positioned inside the structure 260 according to two different orientations. In a first case (FIGS. 2a and 3b) the support 280 forms an angle α of about 45° relative to the base plane of the structure 260; in the second case (FIG. 3c) the support 280 is parallel to the base side of the structure 260.

In both cases shown in the FIGS. 3b and 3c, the illumination means 1 are positioned inside the structure 260 in such conditions to strike the light λᵢ on the sample C with an angle β of 45° relative to the general plane of the lying position of the sample C or the standards. The detection means 3 of the reflected light λᵣ of the sample C are, in turn, oriented so as to form an angle of 90° with the lying plane of the sample C and positioned at a distance of about 25 cm from the sample C itself. In each case, a black cloth covering of the exposure 2 and acquisition 3 systems is foreseen, diagrammatically depicted by the dashed line 261 in the FIG. 3c.

From the comparison of FIG. 3b with FIG. 3c, it results that:
in the case of FIG. 3b, the illumination radiation propagates in a vertical direction and the reflected light is measured according to a trajectory inclined of 45° with respect to the base plane of the “dark room”;
in the case of FIG. 3c, two illumination sources 1 are present, from which two illumination beams, inclined in opposite direction of 45° relative to the bottom plane of the dark room 2 are propagated, while the reflected light is vertically measured by the detection means 3.

The solution of FIG. 3c allows to obtain, if necessary, a greater uniformity of illumination.

The tests carried out so far by the Applicant have shown that by operating with an angle of incidence equal to 45° of the light emitted from the source 1 on the sample C, the problems relating to the internal reflection phenomena of the sample are minimized. Furthermore, it has been checked that a good illumination source consists of LEDs with a colour temperature of about 5500° K. For specific cases, such as for example the one depicted in FIG. 3c, it is possible to use an illumination system with optical fibers. In addition to the support 280 of the sample, also the illuminations 1 are movable, so as to allow different acquisition procedures.

When one desires to measure the colour of a head of hair, the “dark room” 2 can typically present a generically helmet-shaped structure (FIG. 4), equipped with proper illumination means 1 positioned at the sides of the digital camera/videocamera 3 and oriented so as to form an angle β of about 45° relative to the tangent of the portion of hair C to be analyzed. The whole according to a geometry substantially assimilable to that of FIG. 3c.

The method for the colour measurement of a sample of unhomogeneous material substantially foresees the following operations:

a) arrange a sample C of a material to be analyzed and proper colour standards within the “dark room” 2,

b) illuminate, with illumination means 1, the sample C to be analyzed and the colour standards,

c) detect the digital image of the sample C and the colour standards illuminated by the illumination source 1 through detection means 3,

d) determine the mean colour of the sample through processing means 4, where the means 4 are calibrated on the reference standards.

The reference standards for the calibration of the system are suitably determined and tested for the construction of calibration curves for the different shades of hair (natural, decolorized or dyed). An example is constituted by the colours defined with the colour coordinates given in table 2.

TABLE 2

| Sample | X | Y | Z | R | G | B |
|---|---|---|---|---|---|---|
| Sample 1 | 17.19 | 18.09 | 12.57 | 128 | 117 | 91 |
| Sample 2 | 66.42 | 68.23 | 24.73 | 252 | 210 | 111 |
| Sample 3 | 53.94 | 51.23 | 20.74 | 238 | 178 | 106 |
| Sample 4 | 55.85 | 55.30 | 72.70 | 203 | 191 | 216 |
| Sample 5 | 51.90 | 56.84 | 78.37 | 172 | 202 | 223 |
| Sample 6 | 14.75 | 13.93 | 10.26 | 127 | 98 | 83 |
| Sample 7 | 20.52 | 19.35 | 10.56 | 152 | 114 | 81 |
| Sample 8 | 36.06 | 49.99 | 40.88 | 122 | 204 | 159 |
| Sample 9 | 10.87 | 9.60 | 9.76 | 110 | 79 | 84 |
| Sample 10 | 32.00 | 30.36 | 11.95 | 189 | 140 | 81 |
| Sample 11 | 19.25 | 16.50 | 10.53 | 152 | 99 | 83 |
| Sample 12 | 26.92 | 18.98 | 14.59 | 188 | 89 | 101 |
| Sample 13 | 59.80 | 59.51 | 24.97 | 243 | 195 | 116 |
| Sample 14 | 17.34 | 14.00 | 11.41 | 146 | 88 | 89 |
| Sample 15 | 8.51 | 8.74 | 14.43 | 74 | 83 | 104 |
| Sample 16 | 16.43 | 15.25 | 9.49 | 137 | 101 | 79 |

Before proceeding to the measurement of the colour of the sample of interest, it is required to carry out the system validation, checking the repeatability of the “readings” and carrying out the calibration/adjusting of the detection means 3.

The check of the repeatability of the “readings” is carried out in the following way. A series of colour standards is subjected to consecutive readings; the colour histogram on the central portion of the standard surface for each reading is computed, and the mean value for each colour channel in the RGB system is computed, with a following transformation of the RGB notations in coordinates L*a*b*. Subsequently, the colour difference Delta E between each reading is calculated, which is given by the square root of ((L₁−L₀)̂2+(a₁−a₀)̂2+(b₁−b₀)̂2), wherein L₁ and L₀, a₁ and a₀, b₁ and b₀ are the values calculated in each reading. Optimal values of Delta E are lower than 0.2.

The calibration of the detection means 3 is carried out in the following way. A series of colour standards, of which the coordinates L*a*b* are known, are subjected to a reading. By using the readings in RGB notation opportunely transformed in coordinates L*a*b* a calibration curve is constructed (minimum 3 points, showing for each one the input values, equivalent to the readings, and the output values, equivalent to the absolute coordinates of the reference sample). Also in this case the calculation of the Delta E, for checking the correspondence of the values found by applying the calibration curve and the absolute coordinates of the standards, will be used.

The detection method of the reflected light (digital image acquisition) foresees the following operations.

When a scanner 3 is used as a detection system, the sample to be analyzed is positioned on the support 28a, 28b and placed on the reading plane of the scanner, together with a series of specific colour standards. By using the registers system 24, the positioning is carried out so as the readings are performed always in the same position. After having properly positioned the dark room 26a, the readings are carried out, at least 2 for each sample/standard.

When a digital camera/videocamera is used as a detection system 3, the sample to be analyzed is opportunely positioned on the support 280 and placed on the reading plane (inclined or not) together with a series of colour standards. By using the registers system 240, the positioning is carried out so as the readings are performed always in the same position. After having positioned the proper illuminations, one proceeds to the detection of the digital image, carrying out at least 2 readings for each sample/standard.

This method of data detection (digital image) is innovative as, although one operates in a scientific acquisition system of the colour (environment, illuminations, proper calibration systems), it is possible for the operator to see the sample under the same illumination simultaneously with the measurement, otherwise from the classical calorimetric systems. This allows a high comparison level of the numerical data with the visual perception of the colour from the operator, an impossible thing with the classical systems. It is an important aspect, as the determination of the hair colour is strictly connected with aesthetical opinions, for example to the evaluation of the result of a decolourization or a dye.

When one desires to carry out a determination relating to the colour, the colour samples, acquired with the subject under examination, are used by reference. Each colour sample, in a calibrated system, will have to return the same colour coordinates to each reading. Since little variations are possible (in the ambit of limited Delta E values), the acquired images will be corrected so as to maintain constant the reading in the areas relative to the colour samples.

For measurements of an absolute type, a measurement is carried out by using the stored calibration curves.

On the digital images of the locks or the head of hair, the area of interest is selected. When internal shadow zones are present, one operates through the functions of selection of the main colour and the close colours between an interval defined by the operator, so as to minimize the interferences.

For the selected areas, the colour bar graph for each channel of the RGB system, the mean value and the standard deviation are computed, subsequently carrying out the transformation in coordinates L*a*b* (table 3) or in the XYZ system.

TABLE 3

| R/G/B | min | max | pixels | | L*a*b* |
|---|---|---|---|---|---|
| 39.04261 | 10 | 112 | 1808883 | img. 194 | 11.02 |
| 26.52801 | 0 | 88 | 1229069 | | 5.85 |
| 24.78567 | 0 | 83 | 1148345 | | 3.66 |

The present invention can be industrially used for example for evaluating the persistence degree to the washings of a dye and consequently to allow the optimization thereof from the persons who prepares the formulations.

It is also possible to evaluate the effectiveness of preparations with a decolouring action of a different composition or the same preparation with different ways of application.

Still, the differences of a colouring applied on different “matrixes”, such as for example natural hair with different percentages of white, can be evaluated.

It is also possible to use the device according to the present invention for the creation of databases, hair colour atlases, no longer classified according to empirical scales but with objective numerical notations.

The present invention is also applicable to the colour measurement of all those materials with features of a unhomogeneous structure characterized by phenomena of internal reflection, shadow zones, surfaces with a different colour from point to point, such that to render impossible the application of the traditional systems of colour analysis. By way of example, there may be mentioned:

1) animal hairs, natural or synthetic furs,

2) food products, highly divided and with a smooth surface, such as packages of small dragees,

3) jams and fruit preparations for the confectionery having a gelled and smooth structure or containing pieces dipped in a gel,

4) paints or other colouring materials with multiple components, for example containing solid granules.

In the food field, the present invention has been successfully employed by the inventor in the measurement of the ham colour and in the study of its shelf-life; in the colour measurement of jams, sauces, pulps and fruit purees, fruits and vegetables in pieces or small entire fruits, leaved vegetables; measurement of the colour and the structure of foreign bodies and their identification; evaluations on the genuineness of the foods based on the colour evaluation. In the cosmetic field, it has been possible to evaluate the colour of emulsions, gels, oils, ointments, powders and carry out shelf life evaluations.

1. A device for analyzing the color of a nonhomogeneous material, including:
at least an illumination source for illuminating at least a sample of said nonhomogeneous materials,
a display structure for exposing said at least a sample of a nonhomogeneous material to radiation emitted from said at least one illumination source,
detection means for the digital acquisition of an image of said at least a sample of a nonhomogeneous material illuminated from said at least one illumination source, and
processing means for transforming digital acquisition readings of the image of said detection means in coordinates comparable with the perception of the human eye.

2. The device according to claim 1, wherein said at least an illumination source includes illuminating means which minimize the creation of shadows and the internal reflection phenomena.

3. The device according to claim 1, wherein said at least an illumination source includes illuminating means which do not overheat said at least a sample of a nonhomogeneous materials.

4. The device according to claim 1, wherein said at least an illumination source includes illuminating means selected from a group consisting of lamps, LEDs, and optical fibers.

5. The device according to claim 1, wherein said at least an illumination source includes illuminating means with a colour temperature substantially included between 4000 and 7500° Kelvin.

6. The device according to claim 1, wherein said at least an illumination source includes illuminating means susceptible of operating according to a given angle with respect to the lying plane of said at least a sample of a nonhomogeneous materials.

7. The device according to claim 6, wherein said at least an illumination source includes illuminating means susceptible of operating according to an angle of 45° with respect to the lying plane of said at least a sample of a nonhomogeneous material.

8. The device according to claim 1, wherein said at least an illumination source includes illuminating means susceptible of operating according to an angle of 90° with respect to the lying plane of said at least a sample of a nonhomogeneous material.

9. The device according to claim 1, wherein said at least an illumination source includes illuminating means susceptible of operating in a diffused light.

10. The device according to claim 1, wherein said display structure is substantially absorbent towards the radiation emitted from said at least an illuminating source.

11. The device according to claim 1, wherein said display structure substantially consists of a dark room.

12. The device according to claim 1, wherein said display structure is substantially reflecting towards the radiation emitted from said at least an illuminating sources.

13. The device according to claim 12, wherein said display structure is equipped with dark zones for trapping the radiation reflected in a specular way and allowing the measurement of the radiation diffused from said sample of said nonhomogeneous material.

14. The device according to claim 1, wherein said display structure is equipped with support means shaped for supporting said at least one sample of a nonhomogeneous material comprising at least one of a head of hair, single locks of hair, a single hair, and a plurality of locks of hair.

15. The device according to claim 1 wherein said display structure is equipped with support means shaped for supporting, in a possible combination with said at least a sample of a nonhomogeneous material, at least a reference standard of a known color.

16. The device according to claim 1 wherein said display structure is shaped for allowing the visual observation of said at least a sample of a nonhomogeneous material in a way co-ordinated with the digital acquisition of the image of said at least a sample by said detection means, so as to allow the comparison between the color evaluation from the operator and the instrumental reading.

17. The device according to claim 1, wherein said detecting means for the digital acquisition of the image comprise at least one of scanners, digital cameras, digital videocameras and mother electronic acquisition devices.

18. The device according to claim 1 wherein within said detecting means for the digital acquisition of the image the function of color correction is inhibited.

19. The device according to claim 1, wherein said detecting means for the digital acquisition of the image are couplable to calibration and/or adjusting means for different kinds of color of said at least one sample.

20. The device according to claim 19, wherein said calibration and/or adjusting means include at least a reference standard of a known color susceptible of being arranged in said display structure so as to be exposed to the radiation emitted from said at least one illumination source.

21. The device according to claim 19, wherein said calibration and/or adjusting means include predetermined digital profiles of digital images noticeable from said detecting means.

22. The device according to claim 1, wherein said processing means comprise at least one of personal computers (PC), monitors, and printers with a processing ability of color data.

23. The device according to claim 1 wherein said processing means are set for playing functions comprising at least one of color profile management, selection of reading areas, selected reading of colours, removal of residual shadow zones, transformations for the determination of the gray level, creation of calibration curves, generation of color histograms, data exportation, color management on the printing peripherals, and monitor calibration.

24. The device according to claim 1 wherein said processing means are configured to perform a mean color measurement of said at least one sample of a nonhomogeneous materials.

25. The device according to claim 24, wherein said processing means are configured to perform the said mean color measurement by histograms describing the number of pixels belonging to the different levels of color for each channel of a color system, such as the RGB system.

26. The device according to claim 24, wherein said processing means are configured to perform the said measurement of the mean color by the steps of:
generating a histogram curve which graphically describes the mean color of a matrix of pixels, and
describing said mean color by numerical values.

27. The device according to claim 24 wherein said processing means are configured to perform a transformation from said color system, in at least another color representation system.

28-37. (canceled)
